(19) United States
(12) Patent Application Publication
(10) Pub. No.: US 2001/0032141 A1
(43) Pub. Date: Oct. 18, 2001

(54) Method of and apparatus for implementing a return center

(76) Inventor: Eric M. Drattell, Pleasanton, CA (US)

Correspondence Address: Eric Oliver, DICKSTEIN SHAPIRO MORIN & OSHINSKY LLP, 2101 L Street NW, Washington, DC, 20037-1526, US

(21) Appl. No.: 09/741,345

(22) Filed: Dec. 21, 2000

Related U.S. Application Data
(60) Provisional application No. 60/173,509, filed on Dec. 29, 1999.

(51) Int. Cl. G06F 17/60

(52) U.S. Cl. 705/26

(57) ABSTRACT

A business method (and corresponding apparatus) provides retailers with an outsourced return center for processing merchandise returns. The return center provides a dedicated work-force having expertise in returns processing located in a plurality of individual location near customer locales. A customer desiring the return of merchandise to a retailer can have the return processed at the nearest location, receiving immediate credit in accordance with the retailer's return policy. The use of the return center reduces or eliminates the costs and hassles of returning merchandise to retailers, and offers retailers expert management to ensure the most efficient handling of the returns process.

This application derives from and claims the benefit of U.S. Provisional Application Ser. No. 60/173,509, filed Dec. 29, 1999, which is incorporated herein by reference.

### BACKGROUND

Internet-only retailers (also known as “e-retailers”) have raced to develop their Web sites into user-friendly navigable sites that offer wide selections of merchandise and permit secure transactions. Every detail of the Web site from the moment the user arrives at the site, to the placement of the order, and even the tracking of the shipment is scrutinized to ensure that the overall experience is pleasing to the user. Little attention, however, is given to one of the most critical aspects of the user experience with retailing: merchandise returns.

True e-retailers have no off-line presence, and thus, every return that is made by a user must be sent through the mail back to the e-retailer. Many e-etailers require that users returning merchandise pay a “re-stocking” fee, require that the users pay their own shipping costs for returns, or both. Such policies offend many consumers because of the costs of the returns, as well as the burden of repacking and shipping the merchandise back to the e-retailer.

Moreover, e-retailers have little experience in processing merchandise returns efficiently. If not managed properly, returns can eat away at a substantial portion, if not all, of the profit margins of retailers. In the consumer electronics industry, for example, product returns cost more than $15 billion a year.

### SUMMARY

A business method (and corresponding apparatus) provides retailers with an outsourced return center for processing merchandise returns. The return center provides a dedicated work-force having expertise in returns processing located in a plurality of individual locations near customer locales. A customer desiring the return of merchandise to a retailer can have the return processed at the nearest location, receiving immediate credit in accordance with the retailer's return policy. The use of the return center reduces or eliminates the costs and hassles of returning merchandise to retailers, and offers retailers expert management to ensure the most efficient handling of the returns process.

### BRIEF DESCRIPTION OF DRAWINGS

FIG. 1 illustrates process flow of a return process in accordance with a preferred embodiment of the invention;

FIG. 2 illustrates process flow of an exemplary commercial implementation of a preferred embodiment of the invention; and

FIG. 3 illustrates a block diagram of a computer system used to implement a preferred embodiment of the invention.

### DETAILED DESCRIPTION

Preferred embodiments and applications of the invention will now be described herein. Other embodiments may be realized and structural or logical changes may be made to the disclosed embodiments without departing from the spirit or scope of the invention. Although the invention is particularly described as applied to the local return processing for e-retailers, it should be readily apparent that the invention may be embodied in any returns process or other mechanism having the same or similar problems.

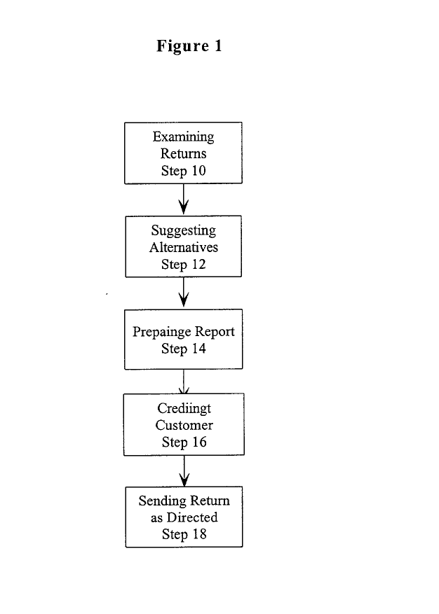

In accordance with a preferred embodiment of the invention, a return center is provided for retailers to outsource the management of returns from customers. In a preferred embodiment, the returns process may involve (as illustrated in FIG. 1) the steps of: examining the returned merchandise (step 10); suggesting alternatives to returning the merchandise (e.g., replacing batteries, providing usage instructions, troubleshooting, etc.) (step 12); preparing a report of the condition of the merchandise and reason for return (step 14); crediting the customer for the merchandise in accordance with the policies of the particular retailer (step 16); and sending the returned merchandise to the retailer, fulfillment center, manufacturer, or other depository, as directed by the retailer (step 18). In a preferred embodiment, the return center (TRC) contracts with one or more different retailers (e.g., e-retailers, “brick-and-mortar” national retailers, local “mom-and-pop” retailers, etc.). Any number of compensation arrangements (e.g., flat fee, percentage of merchandise value, fee-per-service, etc.) can be made with the individual retailers to compensate TRC for its services.

In a preferred embodiment, TRC provides a series of locations throughout the customer region of the retailer (e.g., regional, national, international locations, etc.). TRC may provide its own stand-alone locations, provide for franchises branded (or co-branded) with the TRC corporate name, or provide partnerships or alliances with other retailers/service providers (e.g., BestBuy, etc.) having established locations in the desired areas, or those who have infrastructure servicing individual customers (e.g., FedEx, UPS, courier services, etc.). A central TRC location may also be provided in accordance with a preferred embodiment to facilitate distribution of returns and provide central management of the series of locations. The central TRC (as well as the many TRC locations) can provide call centers to field questions from both customers and retailers alike.

### EXAMPLE

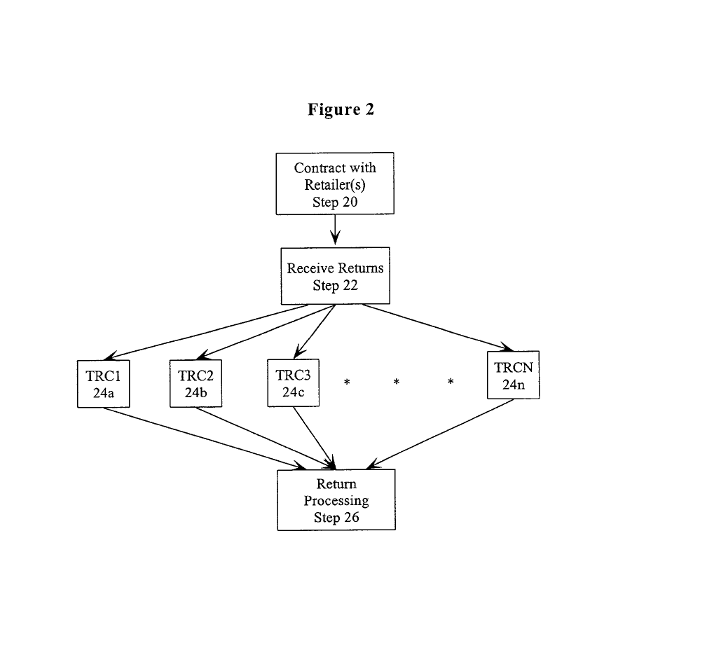

As an illustration of a commercial embodiment of the invention, one implementation of the invention in a Web site, “ReturnCenter.Com,” is provided below, the process flow of which is depicted in FIG. 2.

### The ReturnCenter.Com

The Return Center.Com (“TRC”) processes returns on behalf of eretailers through a nationwide network of franchisees. E-retailers which contract with TRC offer a value add over e-retailers that do not provide consumers with a convenient way to return merchandise and obtain instant credit in accordance with the retailer's published return and credit policies.

### E-retailers

TRC contracts with e-retailers to process their returns (step 20). The e-retailers either pay a fixed annual fee for the service, a monthly fee based on returns processed, and/or a fee per return (either fixed or a percentage of the price of the returned item). Payment is made electronically, and in the case of fee per return payments, the electronic payment due TRC is stripped off the fee per return paid by the e-retailers to the TRC franchisee and electronically remitted to TRC. The e-retailers will advertise to consumers that they can return merchandise to any of TRC's franchisees, which are located nationwide.

TRC also offers a customer service call center that e-retailers can direct consumers to call concerning merchandise return questions. Each e-retailer is given an individual toll free number, and TRC answers calls in the name of the e-retailer.

### Processing Returns

A user is informed that it can return merchandise (step 22) to any one of a plurality of TRCs (TRC₁, TRC₂, TRC₃, . . TRC_{N}) in the nationwide network (step 24a, 24b, 24c, . . . 24n). The TRC franchisee may trade under its own name, under the TRC name, or co-branded with TRC. TRC will perform return processing (step 26), including accepting all returns that conform to the retailer's published policies, issue instant credit to the consumer (as a credit to the consumer's credit card account), and return the merchandise to the retailer or the manufacturer, as directed. TRC franchisees are paid per return regardless of TRC's arrangement with the e-retailer. The TRC franchisee will advise TRC electronically of a return, whereupon TRC will electronically transfer payment of the agreed fee per return to the TRC franchisee. TRC franchisees may also charge consumers directly for packing supplies and postage, if required by the e-retailer's policy.

### Use of the Web

E-retailers will identify on their home pages that consumers can return merchandise to TRC franchisees. TRC will encourage e-retailers to (i) publish their return policies on the Web, and to (ii) provide a link to TRC's Web site, where TRC will list, among other things, the TRC franchisee locations by state, city and zip code. TRC will also make available to e-retailers a recognizable logo that e-retailers can display prominently to notify consumers that the e-retailer offers TRC as a value added service.

TRC will also solicit advertising for its Web site from e-retailers with which TRC has a return processing relationship.

### Catalog Merchants

TRC will also contract with catalog merchants to provide the same service to them as it provides to e-retailers.

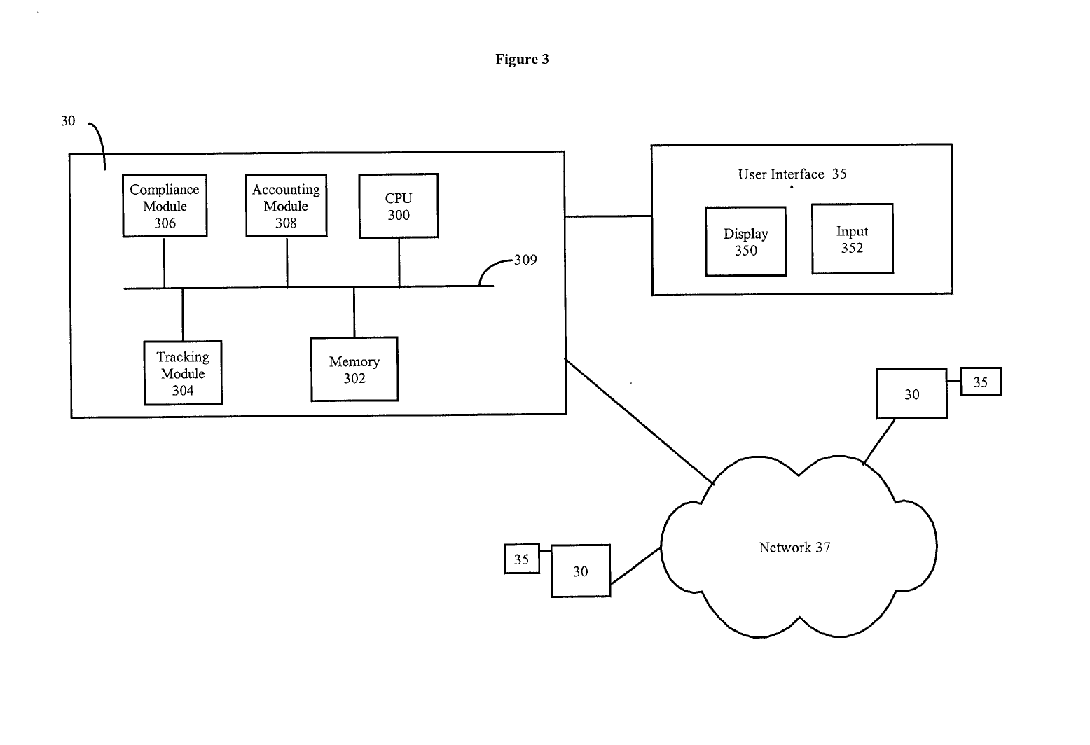

The computer system illustrated in FIG. 3 is composed of a TRC server 30 and user interface 35 for implementing the operations described herein in accordance with preferred embodiments of the invention. (It should be apparent, however, that many, if not all, of the operations described herein may be implemented by hand using physical devices and human intervention in accordance with the teachings herein.) In accordance with a preferred embodiment, TRC server 30 may include one or more central processing units (CPUs) symbolically represented by CPU 300 used to provide processing of input/output data between TRC server 30, user interface 35, and/or network 37, and among the different modules (all connected together via system bus 309) within TRC server 30. CPU 300 typically executes one or more computer programs stored in the one or more memory devices symbolically represented as memory module 302. Additional modules (e.g., tracking module 304, compliance module 306, accounting module 308) may be provided, as will be described below. User interface 35 provides one or more display devices 350 (e.g., CRT, LCD, or other known displays) and one or more input/output devices 352 (e.g., touch screen interface, keyboard, mouse, stylus, push button, lever, or other known input mechanisms) for facilitating the access to the system by a user through user interface 35. Network 37 may take any wired/wireless form of known connective technology (e.g., internal LAN, enterprise WAN, intranet, Internet, Virtual Private Network (VPN), etc.) to allow TRC server 30 to provide local/remote information and control data to/from other locations. In accordance with a preferred embodiment of the invention, the TRC server may be implemented in stand-alone or network devices, as well as serving one or more users over a collection of remote and disparate networks (e.g., Internet, intranet, VPN, etc.).

The computer system described above and illustrated in FIG. 3 may be used to effectuate any one or more aspects of the game operations described in (and apparent from) the specific embodiments, implementations, and illustrations provided herein.

In a preferred embodiment of the invention, a computer system (e.g., as shown in FIG. 3) is provided to facilitate the return processes performed by TRC. The computer system 30 may be centrally located in the central TRC (if used), distributed among the many TRC locations, provided as stand-alone systems, or any combination of these arrangements. In a preferred embodiment, the computer system provides tracking information (e.g., by retailer, manufacturer, product-line, model, serial number, customer, purchase transaction, etc.), preferably, using tracking module 304 to maintain and provide the information. The system provides TRC with a high-level of intelligence to manage efficiently the returns for each retailer thus allowing TRC to ensure compliance with retailer's return policy, prevent fraud, etc. Compliance module 306 is preferably provided to maintain return policy, fraud, and other information pertinent to the retailers (or other business entities) utilizing TRC for processing of returns. Compliance module 306 may be used to detect returns that fail to comply with policies or are suspected of fraud and the like. In a preferred embodiment, the computer system may also control the credits/debits among the customers, TRC franchisees, central TRC, retailers, manufacturers, and fulfillment centers accorded each based on individual return transactions utilizing, for example, accounting module 308.

While preferred embodiments have been specifically described and illustrated herein, it should be apparent that many modifications to the embodiments and implementations of the invention can be made without departing from the spirit or scope of the invention. For example, while only a returns processing method (and corresponding apparatus) has been specifically illustrated as applied to e-retailers, the invention may easily be deployed provide returns processing for “brick-and-mortar” retailers, wholesalers or other distributors, whether having solely local or regional outlets, or national/international outlets. While the illustrated embodiments have not specified the type of communication medium (or protocol) used to connect the various modules (e.g., shown in FIG. 3), it should be apparent that any known wired/wireless technology may be used to implement the invention (e.g., Internet, intranets, private bulletin boards, individual local or wide area networks, proprietary chat rooms, ICQ, IRC channels, instant messaging systems, WAP, bluetooth, etc.) using real-time or non-real-time systems alone or in combination.

In accordance with a preferred embodiment, one or more user interfaces (e.g., user interface 35 (FIG. 3)) are provided as part of (or in conjunction with) the illustrated systems to permit users to interact with the systems. Individual ones of a plurality of devices (e.g., network/stand-alone computers, personal digital assistants (PDAs), WebTV (or other Internet-only) terminals, set-top boxes, cellular/PCS phones, screenphones, pagers, kiosks, or other known (wired or wireless) communication devices, etc.) may similarly be used to execute one or more computer programs (e.g., universal Internet browser programs, dedicated interface programs, etc.) to allow users to interface with the systems in the manner described.

The modules described herein, particularly those illustrated or inherent in the instant disclosure, may be one or more hardware, software, or hybrid components residing in (or distributed among) one or more local or remote computer systems. Although the modules may be shown or described herein as physically separated components (e.g., tracking module 304, compliance module 306, accounting module 308), it should be readily apparent that the modules may be combined or further separated into a variety of different components, sharing different resources (including processing units, memory, clock devices, software routines, etc.) as required for the particular implementation of the embodiments disclosed herein. Indeed, even a single general purpose computer (or other processor-controlled device) executing a program stored on an article of manufacture (e.g., recording medium) to produce the functionality referred to herein may be utilized to implement the illustrated embodiments. User interface devices may be any device used to input and/or output information. The user interface device may be implemented as a graphical user interface (GUI) containing a display or the like, or may be a link to other user input/output devices known in the art.

In addition, memory units described herein may be any one or more of the known storage devices (e.g., Random Access Memory (RAM), Read Only Memory (ROM), hard disk drive (HDD), floppy drive, zip drive, compact disk-ROM, DVD, bubble memory, redundant array of independent disks (RAID), etc.), and may also be one or more memory devices embedded within a CPU, or shared with one or more of the other components.

Accordingly, the invention is not to be limited by the foregoing description of drawings, and only by the claims appended hereto.

What is claimed is:

1. A method of doing business comprising the steps of:
providing a plurality of physical locations for receiving requests for returns of purchased items;
performing returns processing of purchased items for at least one business establishment; and
returning purchased merchandise.

2. The method of claim 1, wherein the purchased items are merchandise purchased from an on-line retailer.

3. The method of claim 1, wherein the purchased items are services purchased from a vendor.

4. The method of claim 1, further comprising contracting with the at least one business establishment to perform returns processing for compensation.

5. The method of claim 4, wherein said contracting is performed with a plurality of business establishments to outsource their respective returns processing needs.

6. The method of claim 4, wherein compensation is in the form of a fixed annual fee for providing returns processing services.

7. The method as recited in claim 1, wherein said providing step includes franchising rights to perform returns processing at one or more of the plurality of physical locations.

8. The method as recited in claim 7, wherein the franchising rights include the right to utilize a single branded name in association with providing return processing services.

9. The method as recited in claim 7, wherein said providing step further includes providing a central location to facilitate distribution of returns and provide central management of the plurality of physical locations.

10. A method of implementing a return center for use in processing returns of merchandise purchased from a retailer, the method comprising the steps of:
contracting with a retailer to provide outsourced return processing services;
providing a plurality of physical locations throughout a customer region of the retailer;
processing at respective ones of the plurality of physical locations returned merchandise purchased from the retailer; and
sending the returned merchandise as directed by the retailer.

11. The method of implementing a return center as recited in claim 10, wherein said processing step comprises:
receiving the returned merchandise from a customer of the retailer;
examining the returned merchandise; and
crediting the customer for the returned merchandise.

12. The method of implementing a return center as recited in claim 11, wherein said processing step further comprises suggesting alternatives to returning the merchandise.

13. The method of implementing a return center as recited in claim 11, wherein said processing step further comprises preparing a report of the condition of the merchandise and reason for return.

14. The method of implementing a return center as recited in claim 11, wherein said sending step comprises sending the returned merchandise to a fulfillment center.

15. The method of implementing a return center as recited in claim 11, wherein said contracting step includes contracting with a plurality of different retailers to perform processing of returns at the same physical locations.

16. An article of manufacture for use in conjunction with a method of processing returns, the article of manufacture having stored thereon an executable program having the processing steps of:
tracking processing of individual items returned;
associating items returned with respective ones of a plurality of business entities;
ensuring compliance of each individual item returned with the return policy of the associated one of the plurality of business entities; and
controlling credits and debits accorded to customers and business entities.

17. The article of manufacture as recited in claim 16, wherein the plurality of business entities include retailers, manufacturers, and fulfillment centers associated with individual return transactions.

18. The article of manufacture as recited in claim 16, wherein the executable program receives input information from a plurality of physical locations distributed nationwide.

19. The article of manufacture as recited in claim 16, wherein said tracking step includes tracking information including, where applicable, by retailer, manufacturer, product-line, model, serial number, customer, and purchase transaction.

20. The article of manufacture as recited in claim 17, wherein the retailers are e-retailers.
